(19) United States
(12) Patent Application Publication
(10) Pub. No.: US 2018/0285524 A1
(43) Pub. Date: Oct. 4, 2018

(54) PRECISION SEARCH AND EXTRACTION OF MEDICAL IMAGES AND DATA IN CLOUD-BASED STORAGE

(71) Applicant: Konica Minolta Healthcare Americas, Inc., Wayne, NJ (US)

(72) Inventors: Takayuki Ishikawa, Wayne, NJ (US); Takao Shiibashi, Wayne, NJ (US)

(73) Assignee: Konica Minolta Healthcare Americas, Inc., Wayne, NJ (US)

(21) Appl. No.: 15/474,420

(22) Filed: Mar. 30, 2017

(51) Int. Cl. G06F 19/00

(52) U.S. Cl. CPC G06F 19/321

(57) ABSTRACT

A method to search, extract, and display medical images and data between a plurality of medical repositories on a plurality of medical servers of healthcare facilities within a network is provided. The plurality of medical servers are connected through a data integration controller and includes a local medical server and two or more remote medical servers. The method causes the local medical server to: transmit a medical data integration request with a search key associated with a predetermined patient to the remote medical servers, receive a medical data associated with the medical data integration request; display the received medical data as an integrated view; perform post-processing on the received medical data; store a condition of the performed post-processing; and apply the same post-processing condition to medical data received from a subsequent medical data integration request associated with the same search key.

### BACKGROUND

Medical images and medical data play a crucial role in the diagnosis or a patient. Healthcare facilities (e.g., hospitals) have realized the benefits of electronically storing medical images and medical data. The digitalization of the medical images and data (“medical data”) not only enables healthcare professionals to easily access medical images and medical data, but also enables the images and data to be easily shared between multiple healthcare facilities through the use of physical mediums such as compact discs (CDs), digital video discs (DVDs), and Universal Serial Bus (USB) flash drives.

More recently, cloud-based storage systems have emerged as a way to improve efficiency and accessibility of information. In general, a “cloud” can be understood as an online storage system that provides remote, on-demand access of computing resources and data over the Internet to multiple computers and devices in various locations. Cloud-based storage may be provided by vendors who use remote or off-site data centers in various locations for storage of data such as medical images. The vendors of the cloud-based storage may also provide a common viewing system (“a universal viewer”) that allows the healthcare facilities to retrieve a complete set of the patient's medical data taken or stored at other healthcare facilities through a single request.

### SUMMARY

In general, in one aspect, the invention relates to a method to search, extract, and display medical images and data between a plurality of medical repositories on a plurality of medical servers of healthcare facilities within a network. The plurality of medical servers are connected through a data integration controller and comprises a local medical server and two or more remote medical servers. The method comprises causing the local medical server to: transmit a medical data integration request through the data integration controller to the remote medical servers, wherein the medical data integration request comprises a search key associated with a predetermined patient; receive a medical data associated with the medical data integration request from the remote medical servers; display the received medical data as an integrated view; perform post-processing on the received medical data based on an input from a user; store a condition of the performed post-processing; apply the same post-processing condition to medical data received from a subsequent medical data integration request associated with the same search key; and display the medical data received from the subsequent medical data integration request as the integrated view.

In general, in one aspect, the invention relates to a non-transitory computer-readable medium (CRM) storing instructions that cause a local medical server coupled to a computer to perform an operation to search, extract, and display medical images and data between a plurality of medical repositories on a plurality of medical servers of healthcare facilities within a network. The plurality of medical servers are connected through a data integration controller and comprises the local medical server and two or more remote medical servers. The operation comprises causing the local medical server to: transmit a medical data integration request through the data integration controller to the remote medical servers, wherein the medical data integration request comprises a search key associated with a predetermined patient; receive a medical data associated with the medical data integration request from the remote medical servers; display the received medical data to a user as an integrated view; perform post-processing on the received medical data based on an input from the user; store a condition of the performed post-processing; apply the same post-processing condition to medical data received from a subsequent medical data integration request associated with the same search key; and display the medical data received from the subsequent medical data integration request as the integrated view.

In general, in one aspect, the invention relates to a system that exchanges medical data between medical severs of healthcare facilities that are part of a network. The system comprises: a local medical server with a medical repository, the local medical server comprises an information addition controller with a data processing unit and an additional information storage unit; and a data integration controller with a communication interface (I/F) circuit that connects the local medical server with two or more remote medical servers with respective medical repositories. The local medical server: transmits a medical data integration request through the data integration controller to the remote medical servers, wherein the medical data integration request comprises a search key associated with a predetermined patient; receives a medical data associated with the medical data integration request from the remote medical servers; displays the received medical data to a user as an integrated view; performs post-processing on the received medical data based on an input from the user; stores a condition of the performed post-processing; applies the same post-processing condition to medical data received from a subsequent medical data integration request associated with the same search key; and displays the medical data received from the subsequent medical data integration request as the integrated view.

Other aspects and advantages of the invention will be apparent from the following description and the appended claims.

### BRIEF DESCRIPTION OF DRAWINGS

FIGS. 1A and 1B show a system in accordance with one or more embodiments.

FIG. 2 shows a system diagram in accordance with one or more embodiments.

FIG. 3 shows a diagram in accordance with one or more embodiments.

FIGS. 4A, 4B, and 4C show a user interface in accordance with one or more embodiments.

FIGS. 5A and 5B show a user interface in accordance with one or more embodiments.

FIG. 6 shows a diagram in accordance with one or more embodiments.

FIG. 7 shows a diagram in accordance with one or more embodiments.

FIG. 8 shows a diagram in accordance with one or more embodiments.

FIG. 9 shows a computing system in accordance with one or more embodiments,

FIG. 10 shows a system diagram in accordance with one or more embodiments,

FIGS. 11A and 11B show a flowchart in accordance with one or more embodiments.

FIGS. 12A and 12B show a flowchart in accordance with one or more embodiments

FIG. 13 shows a flowchart in accordance with one or more embodiments.

### DETAILED DESCRIPTION

Specific embodiments will now be described in detail with reference to the accompanying figures. Like elements in the various figures are denoted by like reference numerals for consistency. Like elements may not be labeled in all figures for the sake of simplicity.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a horizontal beam” includes reference to one or more of such beams.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that, one or more of the steps shown in the flowcharts may be omitted, repeated, and/or performed in a different order than the order shown. Accordingly, the scope of the invention should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

In general, one or more embodiments of the invention provide a method, a non-transitory computer readable medium, and a system configured for searching and extracting medical data (i.e., a patient's complete medical records including all medical images, reports, files, etc.) between healthcare facilities.

With a universal viewer in accordance with one or more embodiments, healthcare facilities that work together as part of a group or network are able to coordinate and deliver a broad spectrum of services to patients of those healthcare facilities. For example, the network may comprise healthcare facilities that are part of the same hospital group or healthcare facilities within a particular region (e.g., a regional medical network). According to one or more embodiments, healthcare facilities that are part of the network (“in-network healthcare facility”) can more effectively utilize the universal viewer to retrieve medical data for patients who frequent one or more of the in-network healthcare facilities.

According to one or more embodiments, each of the in-network healthcare facilities may be associated with one of a cloud-based storage system, a Picture Archiving and Communication System (PACS), or a cloud-based PACS provided by the same vendor or a different vendor. Specifically, each of the in-network healthcare facilities may utilize a different system for storing medical data and may also utilize a unique network for inter-facility communication. For example, each in-network healthcare facility may have a unique security protocol, data encryption method, and network safety and access protocol.

According to one or more embodiments, in response to a search request from one in-network healthcare facility (“request source facility”), all other in-network facilities (“request target facilities”) will transmit medical information (information associated with the medical data) that closely matches a user-inputted search parameter (“search key”) included in the search request. The search key includes simple information associated with a predetermined patient that can be easily retrieved orally from the patient or from the patient's identification card (ID) (e.g., driver license, passport, physical medical insurance card, digital medical insurance card, etc.) without the use of external physical devices (e.g., biometric scanners, card scanners, etc.) and external media (CDs, DVDs, USBs, external hard drives etc.).

According to one or more embodiments, the medical information includes information associated with the medical data but not the actual medical data. The user may choose to retrieve only medical data that are necessary or are of interest to the user because the complete set of the patient's medical data stored in the medical data repositories or databases (“medical repositories”) of the request target facilities may be too big in size and not ail of the data may be required by the user. For example, a user may not want to retrieve medical data that are outdated, related to a diagnosis that would not be useful for the current diagnosis, or related to a different patient. This not only prevents unnecessary storage costs on the medical repository at the healthcare facility that transmits the request, but also decreases the amount of time required to retrieve the medical data.

According to one or more embodiments, the universal viewer includes an image rendering application that allows the user to perform post-processing on the retrieved medical data. For example, the universal viewer allows the user to check the retrieved medical data for medical data not associated with the predetermined patient, medical data that are outdated, medical data that contain incomplete medical information within a medical report embedded in a metadata of the medical data, medical data that include medical images with poor quality that need to be retaken, medical data that the user would not need during subsequent diagnoses, etc. Further, the user may use the post-processing functions of the universal viewer to refine the retrieved medical data so only relevant medical data is displayed. This not only prevents unnecessary storage costs on the medical repository for medical data that the user does not need, but also increases the user's diagnostic efficiency by presenting the user with only the relevant medical data needed for present and future diagnoses.

According to one or more embodiments, the universal viewer saves the user's post-processing preferences for the integrated medical data associated with a predetermined patient in a repository of the first local medical server and a repository of a data integration controller (“an integration data repository”) that processes all of the medical data integration requests as integration history data. The data integration controller refers to the integration history data stored in the integration data repository and automatically applies the saved post-processing preferences to subsequent medical data integrations for the same predetermined patient. This enables the user to perform a more efficient diagnostic during present and subsequent diagnoses as the user would always be presented with medical data that the user has previously concluded to be relevant.

According to one or more embodiments, in the event that a patient's medical data is updated at any one of the multiple in-network healthcare facilities, the universal viewer displays a message to notify all other in-network healthcare facilities that have previously retrieved the medical data. The universal viewer then presents the user with the option to retrieve and view the updated data. For example, if a user at Facility A updates medical data that was previously retrieved by a user at Facility B, the user at Facility B will automatically be notified of the change and given the option to retrieve and view the updated data from Facility A. This enables all of the users among the in-network healthcare facilities to be provided with the most recent and up-to-date medical data.

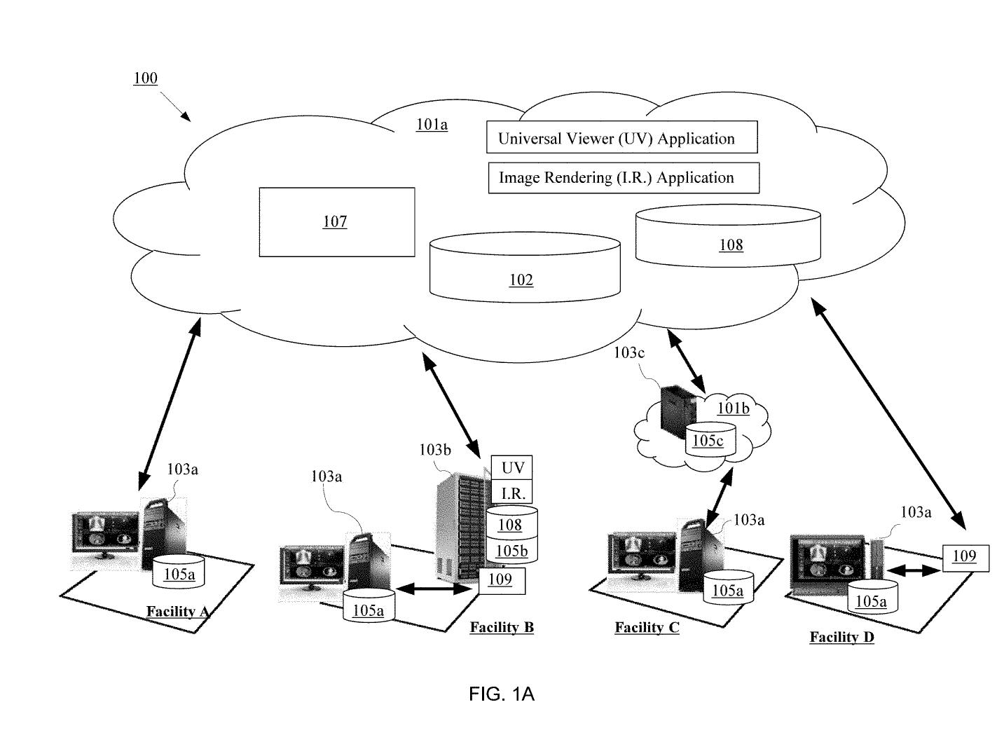

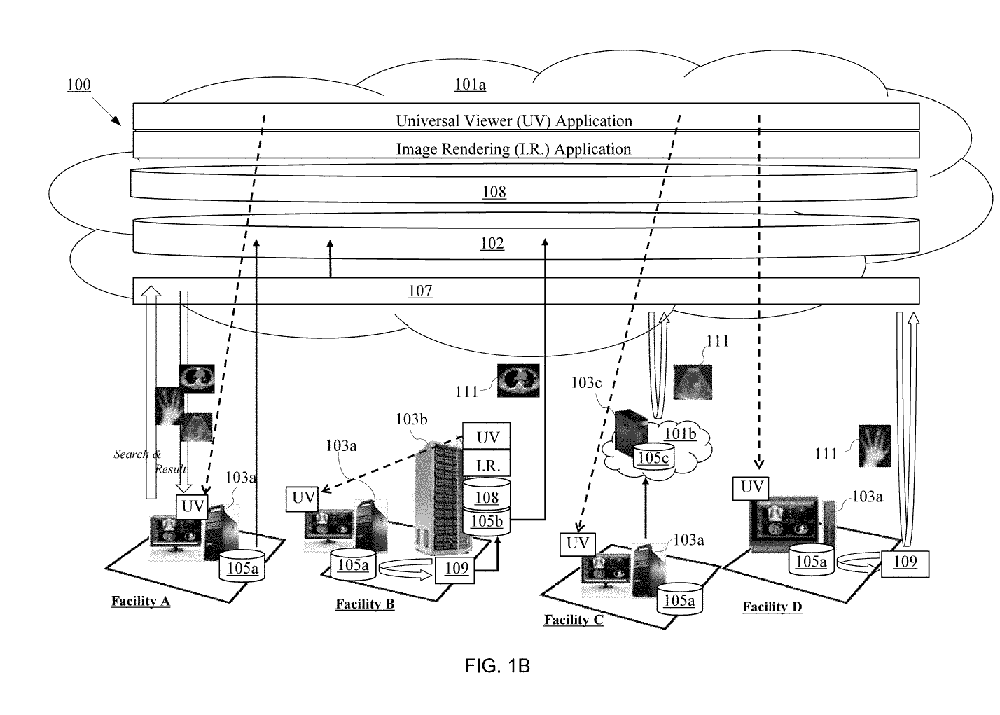

FIGS. 1A and 1B show a system (100) in accordance with one or more embodiments of the invention. As shown, the system (100) includes multiple clouds (101a, 101b), a cloud-based remote medical repository (102), multiple medical servers (103a, 103b, 103c) (e,g., application proxy servers (APS)) with medical repositories (105a, 105b, 105c) associated with different in-network healthcare facilities (Facilities A-D), a data integration controller (107), multiple integration data repositories (108), and multiple gateway devices (109). The medical servers (103a, 103b, 103c) are all coupled to and configured to communicate bilaterally with the data integration controller (107). In addition, the medical servers (103a, 103b, 103c) may exchange medical data with each other through the data integration controller (107). Each of the healthcare facilities may be any type of facility that provides medical care such as a public hospital, a private hospital, a medical clinic, a dental clinic, etc.

In one or more embodiments, each of the medical servers (103a, 103b) is coupled to multiple user computing devices (not shown) (herein referred to as “a local computer”) that are used by healthcare professionals at each in-network healthcare facility. Each local computer may correspond to a personal computer (PC), a laptop, a mobile computing device (e.g., tablet PC, smartphone, etc.), a server, a mainframe, a kiosk, etc. In one or more embodiments, the local computers at each in-network healthcare facility may be configured as a medical server (103a).

In one or more embodiments, the multiple medical servers (103a, 103b, 103c) may be coupled to the same cloud (101a), to a different cloud (101b), or to no cloud. Specifically, in the example shown in FIG. 1A, the medical servers (103a, 103b) of Facilities A-D are disposed locally in each facility and may directly or indirectly share a common cloud (101a) (herein referred to as “a shared cloud server”) provided by the same vendor. One or more facilities can share a shared remote medical repository (102) on the cloud (101a) that may be operated by the same vendor providing the cloud-based PACS or another third-party associated with such a vendor. In one or more embodiments, the shared remote medical repository (102) is an online repository of data. For example, the remote medical repository may be a virtual data room (VDR) or a database (or group of databases) accessed remotely via the Internet.

In one or more embodiments, the in-network healthcare facilities may include a central medical sever (103b), which is shown in the example of Facility B. The central medical server (103b) may be composed of a cluster of servers disposed in a local server room of Facility B. The central medical server (103b) may include a central medical repository (105b) that stores (i.e., backs-up) all of the medical data stored within the medical repositories (105a) associated with each of the individual medical servers (103a) of Facility B. The central medical server (103b) is coupled to each of the individual medical servers (103a) through a gateway device (109) such as a hub or a local area network (LAN) connection and is configured as the main relay point that enables each of the individual medical servers (103a) to communicate with the cloud (101a).

In one or more embodiments, to be able to process all of the data flow within the entire facility, the technical specification and processing capabilities of the central medical repository is higher than that of the individual medical servers (103a). Similarly, the capacity (i.e., storage size) of the central medical repository (105b) would be larger than that of each of the medical repositories (105a) associated with each of the individual medical servers (103a).

In one more embodiments, the medical server (103a) of Facility C communicates bilaterally with a remote medical server (103c) disposed on the cloud (101b) that is different from the cloud (101a). In one or more embodiments, the cloud (101b) may be configured to communicate bilaterally with the cloud (101a). The cloud (101b) may be associated with a cloud-based PACS provided by a vendor that is different from the vendors that provided the cloud server for Facilities A and B.

In one or more embodiments, the remote medical server (103c) of Facility C includes a remote medical repository (105c) that may be operated by the same vendor providing the cloud based PACS for Facility C or another third-party associated with such a vendor. In one or more embodiments, the remote medical server (103c) is a physical and/or virtual computing infrastructure that performs application and information processing. For example, the remote medical server (103c) may be a virtual server or a physical server accessed remotely via the Internet. In one or more embodiments, the remote medical repository (105c) is an online repository of data. For example, the remote medical repository may be a VDR or a database (or group of databases) accessed remotely via the Internet. The medical data stored in the remote medical server (103c) disposed on the cloud (101b) is different from the medical data stored in the medical server (103a) disposed locally in Facility C. Specifically, copies of all of the medical data stored in the medical server (103a) in Facility C are backed-up and available in the remote medical server (103c) disposed in the cloud (101b).

The medical server (103a) of Facility D may be a medical server associated with a PACS provided by the same vendor or a different vendor from the vendor of the cloud (101a) and the vendor of the cloud (101b). The medical server (103a) of Facility D is coupled indirectly to the cloud (101a) through a locally disposed gateway device (109), which will be described later below.

In one or more embodiments, the data integration controller (107) may be disposed on the cloud (101a), the cloud (101b), or another cloud (not shown) within the system. The data integration controller (107) may also be provided locally at each in-network healthcare facility. The data integration controller (107) is configured as a hub for interconnecting the medical servers (103a, 103b) and for relaying requests and medical data between the medical servers (103a, 103b). In addition, the data integration controller (107) may be a computing device that includes one or more computer processor(s), associated memory (e.g., random access memory (RAM), cache memory, flash memory, etc.), one or more storage device(s) (e.g., a hard disk, an optical drive such as a compact disk (CD) drive or digital versatile disk (DVD) drive, a flash memory stick, etc.), and numerous other elements and functionalities.

In one or more embodiments, each of the medical servers (103a, 103b) may be on a different internet network (“network”), which in turn may be different from the network of the data integration controller (107). The network used by the medical servers (103a, 103b) may depend on the service provided by the vendors associated with the in-network healthcare facility's storage and inter-facility communication system. Therefore, the medical servers may communicate with the data integration controller (107) through a gateway device, such as the gateway device (109) of Facility D. The gateway device may be a separate device, such as a simple muter, that connects and passes data between two different devices connected on different networks. In one or more embodiments, the medical server may be configured as the gateway device.

In one or more embodiments, the users at the in-network healthcare facilities (e.g., the healthcare professionals) may access the data integration controller (107) through a universal viewer application (“universal viewer”), which may be provided by the same vendor that provided the cloud and/or PACS service, or a different third-party. The universal viewer may be stored on all of the medical servers (103a, 103b) and may be downloaded to the local computers as a plug-in of a web-browser application with a graphical user interface (“GUI”) that allows the users to operate the universal viewer. Alternatively, the universal viewer may be stored in the cloud (101a) and may be accessed as a web page by inputting a uniform resource locator (URL) (e.g., a web address) associated with the universal viewer into the search bar of the web-browser.

In one or more embodiments, the cloud (101a) is provided with an image rendering application that compiles and performs post-processing to the medical data relayed through the data integration controller (107) and generates the data to be displayed by the universal viewer. The image rendering application may be provided as an extension of the universal viewer application and is physically stored in the same location as the universal viewer application.

In one or more embodiments, the system (100) includes multiple integration data repositories (108) that store all of the history and configuration of the requests and medical data processed by the data integration controller (107), the universal viewer, and the image rendering application. The integration data repository (108) may be provided in the cloud (101a, 101b), the medical server (103a, 103b), or both. In one or more embodiments where the integration data repository (108) is disposed on the cloud (101a, 101b), the integration data repository (108) may be an online repository of data a VDR or a database (or group of databases) accessed remotely via the Internet.

FIG. 1B shows a detailed implementation of the system described in FIG. 1A in accordance with one or more embodiments of the invention.

In one or more embodiments as shown in FIG. 1B, Facilities A and B share the remote medical repository (102) disposed on the cloud (101a) and Facilities C and D do not share the remote medical repository (102). In one or more embodiments, copies of all of the medical data stored in the medical repositories (105a, 105b) coupled to the medical servers (103a, 103b) in Facilities A and B are backed-up and available in the remote medical repository (102) disposed in the cloud (101a). This enables the data integration controller (107) to directly retrieve medical data from the shared medical repository (102) when medical data is required to be retrieved from Facilities A and B.

In one or more embodiments as shown in FIG. 1B, Facility A (“the source facility”) sends a first retrieval request (e.g., represented by the search request arrow) for medical information associated with a predetermined patient. In one or more embodiments, the first retrieval request may include search criteria that include the patient's first name, last name, gender, and date of birth. Other criteria can be used if available to further refine the search, such as the patient's social security number. Further, Facilities B, C, and D (“the target facilities”) may have medical data with information that matches a majority of the search criteria included in the first retrieval request sent by the source facility. Upon receipt of the request from the source facility that Was forwarded through the data integration controller (107), the target facilities transmit medical information associated with these medical data to the data integration controller (107).

In one or more embodiments, upon receipt of the medical information transmitted from the target facilities, the data integration controller (107) organizes the received medical information into a list and transmits the list to the medical server (103a) of the source facility where the list is then displayed to the user, e.g., through the universal viewer accessed by a web-browser on a local computer at the source facility. The user can view the list compiled by the data integration controller (107) and select only the relevant medical data or only the medical data of interest.

In one or more embodiments, once the user selects the medical information of interest from the list, the user transmits a second retrieval request to the data integration controller (107) to retrieve (shown using the curved (or U-turn) arrows) the medical data from the facilities that have the medical data of interest. In the example shown in FIG. 1B, the user is interested in medical data from all of the target facilities. Therefore, the data integration controller (107) sends a second retrieval request to the medical servers (103a, 103b) of all the target facilities to retrieve the medical data associated with the selected medical information.

In one or more embodiments, in response to the second retrieval request to retrieve the medical data, the medical servers (103a, 103b) of the target facilities transmit the medical data requested by the source facility to the data integration controller (107). The data integration controller (107) receives the medical data from the target facilities and creates a data table (not shown) to store the medical information of the received medical data in the integration data repository (108) under a newly created common patient ID (“common Pin”). The medical data are processed by the image rendering application in the cloud (101a) into a format that can be displayed through the universal viewer. The medical data is then forwarded to the source facility where the medical data can be combined with any relevant medical data pre-existing in the source facility and displayed to the user using the universal viewer accessed through a web-browser.

In one or more embodiments as shown in FIG. 1B, because Facility B shares the shared remote medical repository (102) in cloud (101a), copies of the medical data available in the medical servers (103a, 103b) of Facility B are already backed-up and available in the remote medical repository (102). Therefore, the first and second retrieval requests from the source facility are not transmitted by the data integration controller (107) to the medical servers (103a, 130b) of Facility B. Instead, the data integration controller (107) directly retrieves the requested medical information and medical data directly from the shared remote medical repository (102) in cloud (101a).

In one or more embodiments, because Facilities C and D do not share the shared remote medical repository (102) in cloud (101a), the data integration controller (107) retrieves the medical information and medical data associated with Facilities C and D from the shared medical repository (105c) of Facility C and medical repository (105a) of Facility D.

In one or more embodiments, information of the search criteria within the first retrieval request and information from the data table that stores the medical information of the medical data retrieved by the second retrieval request are stored in the integration data repository (108) as integration data (i.e., a search history). In one or more embodiments, the data integration controller (107) automatically sends out a second retrieval request based on the integration data stored in the integration data repository (108).

In one or more embodiments, when the user manually sends a first retrieval request with a search criteria that completely matches a previously-used search criteria, the data integration controller (107) may display a message through a pop-up window in the opened universal viewer to confirm whether the user would like to retrieve the same or different (i.e., additional or less) medical data as the previous identical request. In the event that the user chooses to retrieve the same medical data, the data integration controller (107) will retrieve the integration data stored in the integration data repository (108) and automatically send the second retrieval request to retrieve the medical data.

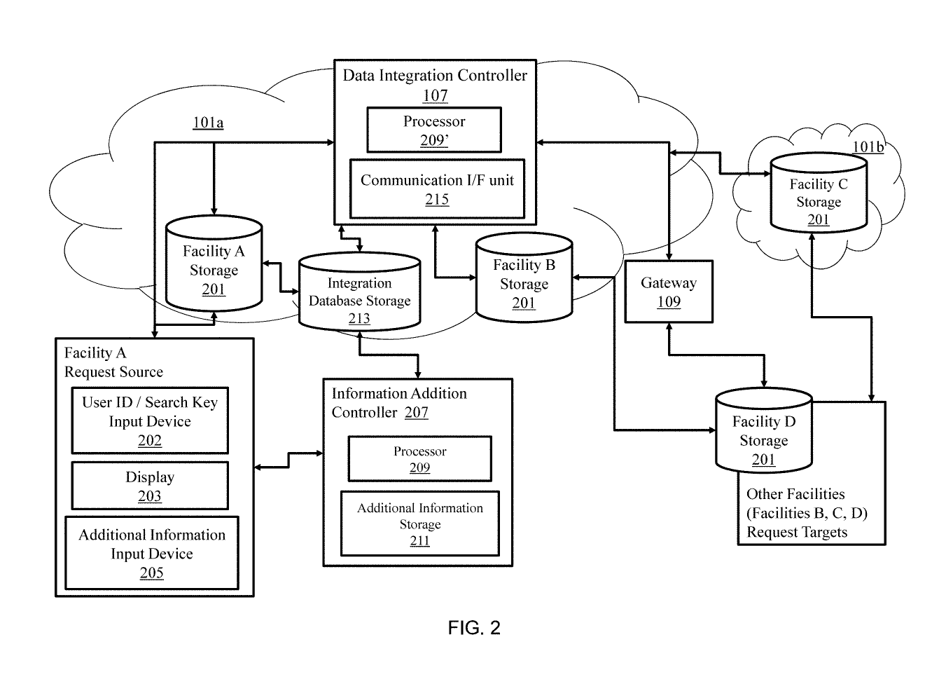

FIG. 2 shows a system diagram in accordance with one or more embodiments of the invention. As shown in FIG. 2, the system according to one or more embodiments includes the four in-network healthcare facilities (Facility A, Facility B, Facility C, Facility D) as described with reference to FIGS. 1A and 1B. The storages (201) of each facility correspond to the medical repositories (105a, 105b, 105c) of each respective facility as described with reference to FIG. 1A.

In one or more embodiments as shown in FIG. 2, Facility A is the facility that sends a search request and a medical data request (“the request source facility”) to the remaining facilities (“the request target facilities”). The request source facility has a local computer that includes a User ID and search key input device (202) (e.g., keyboard, mouse, etc.) for inputting the user's User ID to log in to the universal viewer application and the search parameters that make up the search key, a display (203) (i.e., a monitor or screen) that displays the medical data to the user, and an additional information input device (205) (e.g., keyboard, mouse, etc.) for inputting post-processing instructions on the medical data received from the request target facilities. In one or more embodiments, each of the in-network healthcare facilities may be either the request source facility or the request target facility.

In one or more embodiments as shown in FIG. 2, Facility A also includes an information addition controller (207) that includes a processor (209) that applies the post-processing instructions received by the additional information input device (205) to the medical data displayed on the display (203). In one or more embodiments, the information addition controller (207) also includes an additional information storage (211) that stores all of the information on the post-processing performed on the medical data. In one or more embodiments, the information addition controller (207) may include the image rendering application as described with reference to FIGS. 1A and 1B.

In one or more embodiments, the information addition controller (207) of Facility A may be coupled to an integration database storage (213) disposed on the same cloud as the storage of Facility A. The integration database storage may be the integration data repository (108) as described above with reference to FIGS. 1A and 1B. In one or more embodiments, the integration database storage (213) stores ail of the history and configuration of the requests and medical data processed by the data integration controller (107), the information addition controller (207), the universal viewer, and the image rendering application. In one or more embodiments, the post-processing information stored in the additional information storage (211) of the information addition controller is also saved (i,e., backed-up) in the integration database storage (213).

In one or more embodiments, each of the target facilities may also include its own information addition controller (207) and integration database storage (213). Alternatively, in one or more embodiments, each of the target facilities may only include the information addition controller (207) coupled with a shared integration database storage (213) disposed on the cloud (101a). Alternatively, the shared integration database storage may be disposed on the cloud (101b) or locally at one of the Facilities D.

In one or more embodiments as shown in FIG. 2, the integration database storage (213) is disposed on the same cloud (101a) as the storages (201) of Facilities A and B while the information addition controller (207) is disposed locally at Facility A, but the invention is not limited to this configuration. For example, in one or more embodiments, the information addition controller (207) may be disposed on the same cloud (101a) as the integration database storage (213). Alternatively, the integration database storage (213) and the information addition controller (207) may both be disposed locally at Facility A.

In one or more embodiments, the storage (201) of each facility may be disposed either locally in the respective healthcare facility or remotely on a cloud (101a, 101b). In the example shown in FIG. 2, the storages of Facilities A and B are disposed in the same cloud (101a), the storage of the Facility C is disposed on a different cloud (101b), and the storage of Facility D is disposed locally at Facility D. Each of the storages (201) may be associated with a different network, while the storages (201) disposed in the same cloud (101a, 101b) may share the same network. Further, as described with reference to FIGS. 1A and 1B above, the storages (201) of Facility A and B may be the same storage (201).

In one or more embodiments as shown in FIG. 2, the data integration controller (107) as described with reference to FIG. 1A is disposed in the same cloud (101a) as the storages (201) of Facilities A and B. Alternatively, the data integration controller (107) may instead be disposed on a cloud different from the clouds (101a, 101b) that host the storages (201) of Facilities A and C or locally at any one of the in-network facilities.

In one or more embodiments the data integration controller (107) includes a processor (209′) that processes the search request (i.e., relays the search request, the medical data request, the medical information, and medical data between the different storages) and a communication I/F (215) (communication interface) that is configured as a main hub that connects all of the storages (201) to a network associated with the data integration controller (107). Each of the storages communicates with the data integration controller through the local gateway (109) as described in FIGS. 1A and 1B that connects each of the storages (201) to the communication I/F (215) of the data integration controller (107). The local gateway (109) of each of the four in-network healthcare facilities may be the medical servers (103a, 103b, 103c) that the storages (201) are disposed in or may be a separate device.

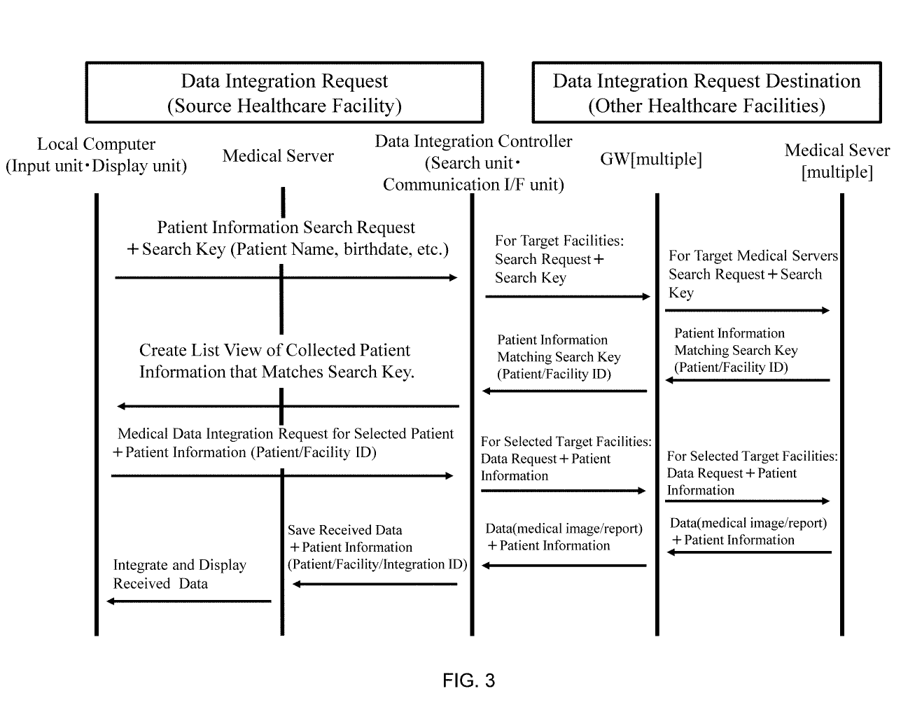

FIG. 3 shows a communication diagram in accordance with one or more embodiments of the invention. The communication diagram illustrates a communication method of one or more embodiments that is implemented by the system as shown in FIG. 2. The communication diagram illustrates the path of the signals transmitted in response to a request from one of the in-network healthcare facilities to retrieve medical data (“a data integration request”).

In one or more embodiments as shown in FIG. 3, the data integration request originates from a local computer of a source healthcare facility (the request source facility as illustrated in FIG. 2). The data integration request is initially sent as a patient information search request (“search request”) from the local computer coupled to a medical server at the request source facility to the data integration controller. The search request includes a search key made up of a string of patient information associated with a predetermined patient. The patient information may include the patient's name, gender, and date of birth; the facility identification (ID) of the healthcare facilities associated with the patient; the type of modalities used for the patient's diagnosis; etc.

In one or more embodiments, the data integration controller receives the search request and relays the search request to the medical servers of a data integration request destination (the request target facilities as illustrated in FIG. 2). The medical servers of the request target facilities may receive the search request through local gateway devices coupled to the medical servers. In one or more embodiments, the medical servers may be configured as the local gateway.

In one or more embodiments, the medical servers of the request target facilities process the received search request and transmit medical information that matches the search request to the data integration controller. The data integration controller receives the medical information from the request target facilities, compiles the medical information into a list, and transmits the list to the local computer of the request source facility.

In one or more embodiments, the local computer displays the received list of medical information to the user. The user selects the medical data associated with the received medical information that the user wants to integrate retrieve). Once the user confirms the medical data to be integrated, the local computer transmits a medical data retrieval request (“a retrieval request”) to the data integration controller. The data integration controller processes the retrieval request and transmits the retrieval request to the medical servers of selected request target facilities associated with the requested data (i.e., the request is only transmitted to the target facilities that have the requested medical data).

In one or more embodiments, the selected target facilities receive and process the retrieval request and transmit the requested medical data to the data integration controller. The data integration controller receives the requested medical data from the selected request target facilities and forwards the medical data to the medical server of the request source facility. The request source facility receives the medical data from the data integration controller, saves the received medical data, integrates received data into a single file, and displays the integrated medical data on the local computer.

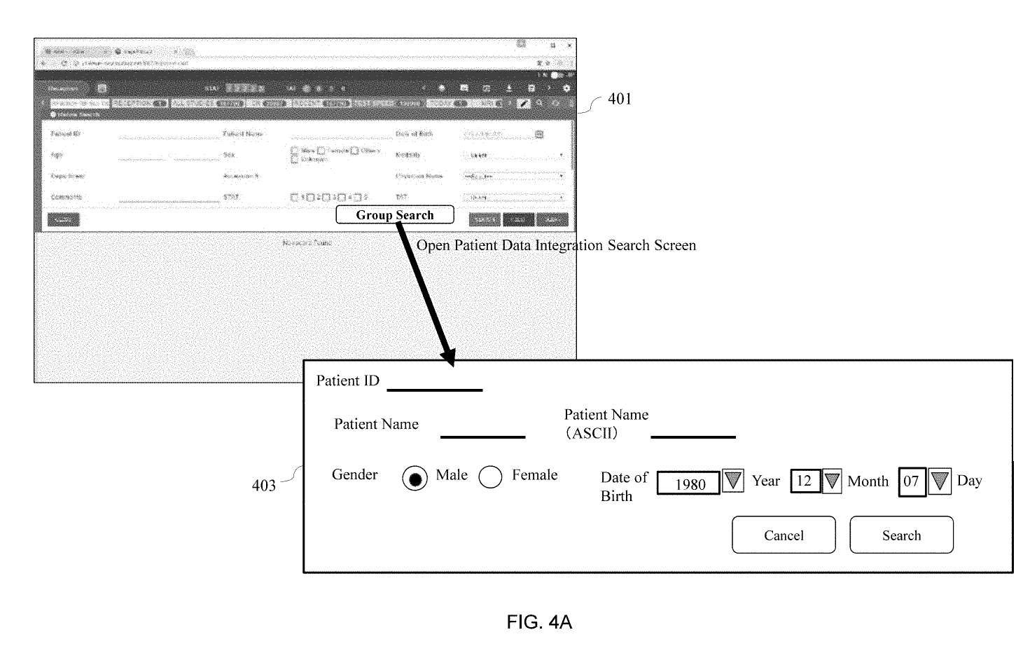

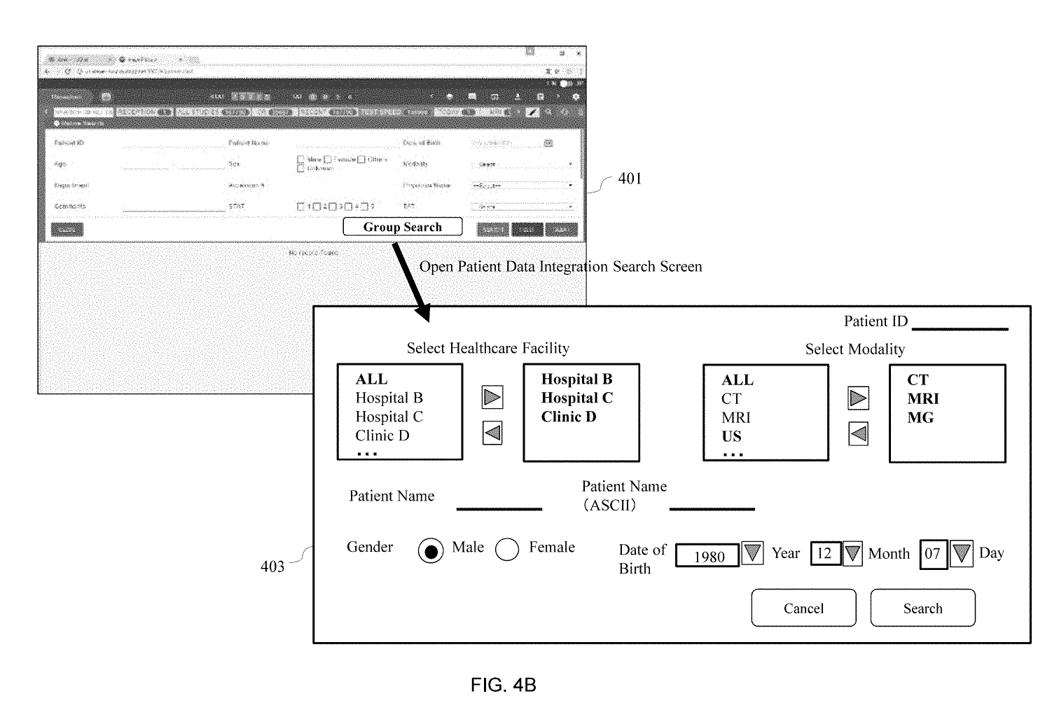

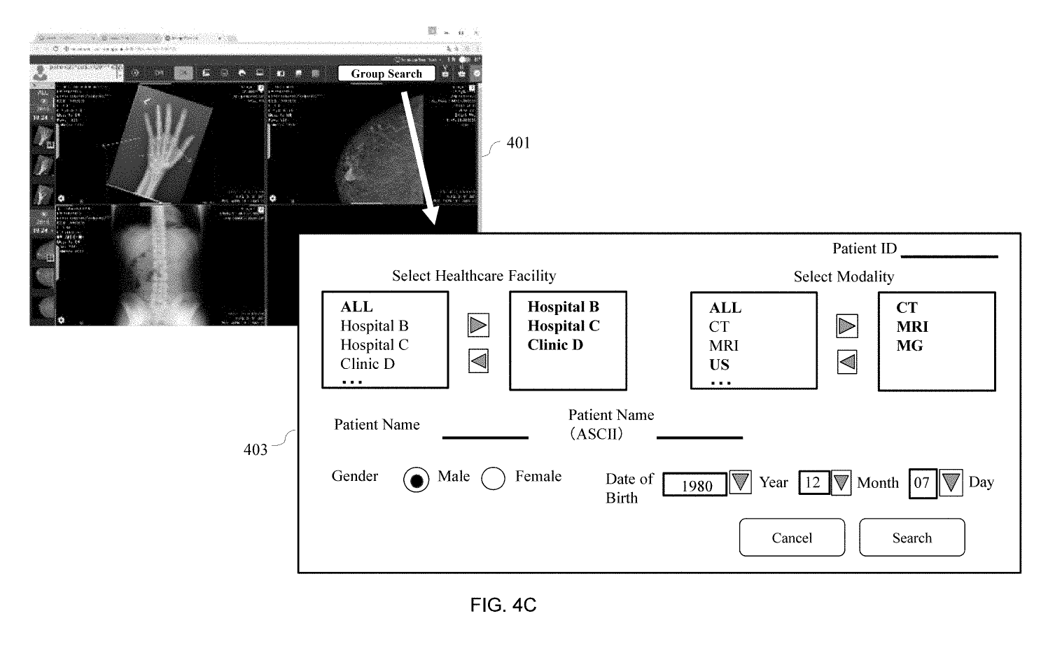

FIGS. 4A, 4B, and 4C show a user-interface in accordance with one or more embodiments of the invention. As shown is FIGS. 4A to 4C, the user may access the universal viewer through a web-browser (401). The universal viewer in this example includes a search option that, when selected by the user, opens a Patient Data Integration Search Screen (“a search interface”) (403) to the user.

In one or more embodiments, as shown in FIG. 4A, an initial start-up page of the universal viewer may be displayed in a tab of the web-browser (401). The user of the universal viewer may access the start-up page by entering the web address associated with the universal viewer into the search bar of the web-browser (401).

In one or more embodiments, the user may be prompted to enter access information that includes a designated USER ID and a user-set PASSWORD that indicates that the user has authorization to access the universal viewer. The user may only be prompted to enter access information when the universal viewer is opened for the first time since the web-browser (401) was last closed by the user. In one or more embodiments, the user may be prompted to enter the access information every time the user opens the universal viewer.

In one or more embodiments, the user may also open multiple tabs and access the universal viewer through all of the opened tabs. Each of the universal viewers opened in each tab of the web-browser (401) is independent of each other. For example, changes made by the user to the universal viewer in one tab would not be applied to the universal viewer opened on a different tab.

In one or more embodiments, the search interface (403) as shown in FIG. 4A includes search parameters that make up the search key included in the user's search request. The search interface (403) includes a parameter for inputting a Patient ID, a Patient Name in regular alphabets, a Patient Name in ASCII format, and parameters for selecting a patient's gender, and the year, month, and day of the patient's date of birth. The search interface (403) further includes two user-selectable tabs to either cancel (CANCEL) the search request (i.e., dose out of the search interface) or submit the search request (SEARCH). In one or more embodiments, the search parameters may be manually entered by the user on the search interface (403). Alternatively, in the event that the user opens the search interface when information on the patient of interest has already been loaded on the web-browser (401), the parameters of the search interface (403) will be automatically completed (i.e., automatically filled in by the universal viewer) based on the patient information loaded on the web-browser (401).

In one or more embodiments, not all of the parameters in the search interface (403) need to be completed by the user in order for the user to submit the search. For example, the user may submit the search request with only the date of birth of the patient or with only the combination of the patient name and the patient's gender. One of ordinary skill would appreciate that as more parameters in the search interface (403) are filled, a more refined search will be conducted by the universal viewer application.

In one or more embodiments as shown in FIG. 4B, the search interface (403) may also include more advanced search parameters such as a parameter for selecting the target in-network healthcare facilities (“request target facilities”) that will receive the search request, and a parameter for selecting the modality that acquired the medical data. As shown in FIG. 4B, Hospital B, Hospital C, and Clinic F are selected as target facilities that will receive the search request, and the search request is directed to medical data associated with the CT, MRI, and MG modalities. One of ordinary skill would appreciate that various other search parameters may be used that are not specifically shown, e.g., the patient's blood type.

In one or more embodiments as shown in FIG. 4C, the user may access the search interface (403) at any time through the universal viewer application. In the example of FIG. 4C, the web-browser (401) is displaying a patient diagnosis tab that includes multiple medical data currently being viewed by the user.

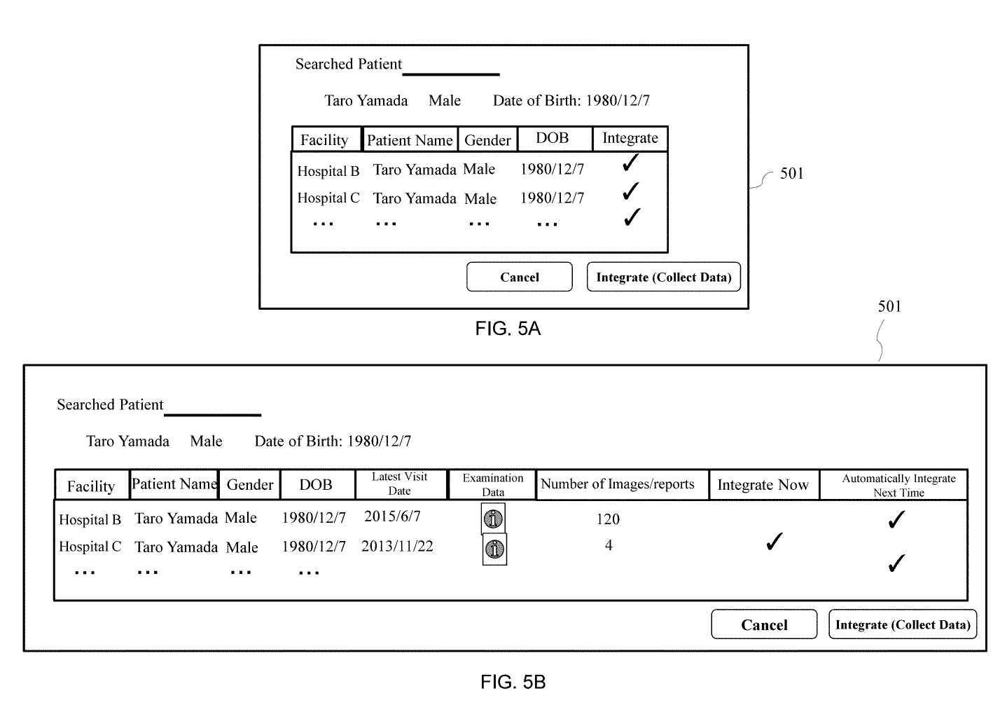

FIGS. 5A and 5B show a user-interface (501) that includes the list or medical information compiled by the data integration controller (107) in accordance with one or more embodiments of the invention. As shown in FIG. 5A, the user-interface (501) includes the information (e.g., the patient's name, the patient's gender, the patient's date of birth) of the predetermined patient entered in the search request (“search request”). The user-interface (501) further displays the list of medical information and sorts the medical information by Facility, Patient Name, Gender, Date of Birth (“DOB”). In addition, the user-interface (501) includes an option for the user to select all of the medical information of interest from the list (i.e., the integrate column). Once the user selects all the medical information of interest, the user may either submit the search request (SEARCH) or cancel (CANCEL) the search request (i.e., close out of the search interface).

FIG. 5B shows an example of the user-interface (501) in accordance with one or more embodiments of the invention. The user-interface (501) as shown in FIG. 5B displays additional information such as a Patient's Latest Visit Date, information on the Examination Data, and the Number of Images/Reports in the medical data. In one or more embodiments, clicking on the icon in the Examination Data column will open a pop-up window displaying detailed information on the diagnosis related to the medical information. Additionally, the user-interface in this example further includes an option for select medical information which the user wants to retrieve immediately (Integrate Now) and an option for selecting which medical information will be automatically retrieved next time the same search request is sent (Automatically Integrate Next Time).

In one or more embodiments as shown in FIGS. 5A and 5B, the medical information displayed in the user-interface (501) is saved as metadata of the corresponding medical data.

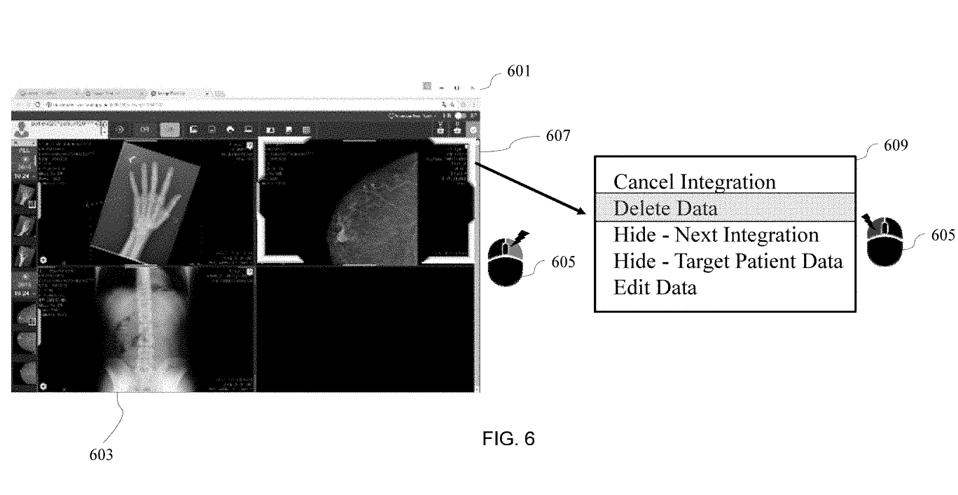

FIG. 6 shows a diagram in accordance with one or more embodiments of the invention that illustrates an event where a user performs post-processing on the displayed integrated medical data.

In one or more embodiments as shown in FIG. 6, a universal viewer opened in a tab of browser (601) is displaying an integrated view of three medical data (603) that were retrieved based on the user's medical data integration request using a specific search key. The user may review each medical data (603) to determine if any post-processing is required to be performed on the displayed integrated medical data.

In one or more embodiments, when the user performs a click using a mouse (605) when the mouse cursor (not shown) is placed above an area of the medical data (603), a selection box (607) appears over the medical data (603) to highlight the selected medical data (603). In the event that the user performs a left-click using the mouse (605), the color of the selection box (607) may be blue. In the event that the user performs a right-click using the mouse (605), the color of the selection box (607) may be red, which indicates that the selected medical data (603) is pending post-processing, and a pop-up window (609) would appear in close proximity to the mouse cursor (in the event that the mouse is programmed for a left-handed user, a right-click of the mouse (605) would result in a blue selection box and a left-click would result in a red selection box and the appearance of the pop-up window (609)). In one or more embodiments, the mouse (605) may be any other input device that can be configured to include multiple input functions (e.g., left click and right click) such as a touch pad, a stylus, a keyboard, etc.

In one or more embodiments, the pop-up window (609) includes the post-processing options that the user can perform on the selected medical data (603). The post-processing options displayed in the pop-up window (609) may include Cancel Integration, Delete Data, Hide-Next Integration, Hide Target Patient Data, and Edit Data.

In one or more embodiments, when the user selects the Cancel Integration option, all of the medical data (603) displayed in the universal viewer tab will be removed (i.e., the integration of the medical data has been cancelled by the user).

In one or more embodiments, when the user selects the Delete Data option, the selected medical data (603) will be deleted from the integrated view displayed in the universal viewer tab.

In one or more embodiments, when the user selects the Hide Next Integration option, the selected medical data (603) will not be displayed (i.e., hidden, not visible) in an integrated view generated by subsequent medical data integration requests associated with the same search key as the present medical data integration request.

In one or more embodiments, when the user selects the Hide-Target Patient Data, all medical data (603) within the integrated view associated with the same patient as the selected medical data (603) will become hidden within the integrated view and are no longer visible to the user.

In one or more embodiments, when the user selects the Edit Data option, a new pop-up window displaying a GUI (not shown) will appear that allows the user to edit the metadata associated with the selected medical data (603).

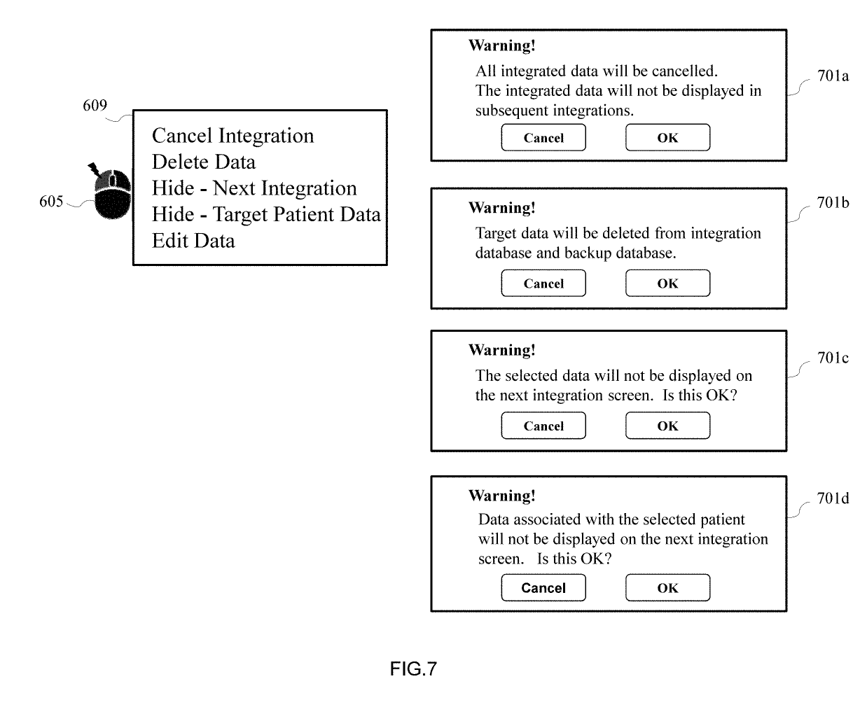

FIG. 7 shows a diagram in accordance with one or more embodiments of the invention that illustrates an event that occurs when a user selects one of the possible post-processing options as shown in FIG. 6.

In one or more embodiments, when the user selects one of the post-processing options shown in the pop-up menu (609) using the mouse (605), a pop-up window (701a-d) displaying a warning message will appear. The pop-up window (701a-d) may display a warning that includes a description of the action associated with the option selected by the user, the effects of the action on subsequent medical data integration requests associated with the same search key as the present medical data integration request, and a question to the user confirming if the user wishes to continue with the selected option.

For example, in one or more embodiments as shown in FIG. 7, when the user selects the Cancel Integration option, the pop-up window (701a) will appear to warn the user that the user is about to cancel the integrated view, all of the integrated data (i.e., medical data) will be cancelled, and that the same integrated view will not be displayed again in integrated views generated from subsequent medical data integration requests associated with the same search key as the present medical data integration request. Similarly, example warnings of the Delete Data option, the Hide-Next Integration option, and the Hide Target Patient Data option are shown in pop-up windows (701b-d), respectively.

It would be apparent to one of ordinary skill that an example warning for the Edit Data option would be an initial message confirming if the user wishes to edit the metadata of the selected medical data before the user is presented with a pop-up window with a GUI for editing the metadata, and a subsequent warning message confirming if the user wants to apply the edits to the selected medical data after the user finishes editing the metadata.

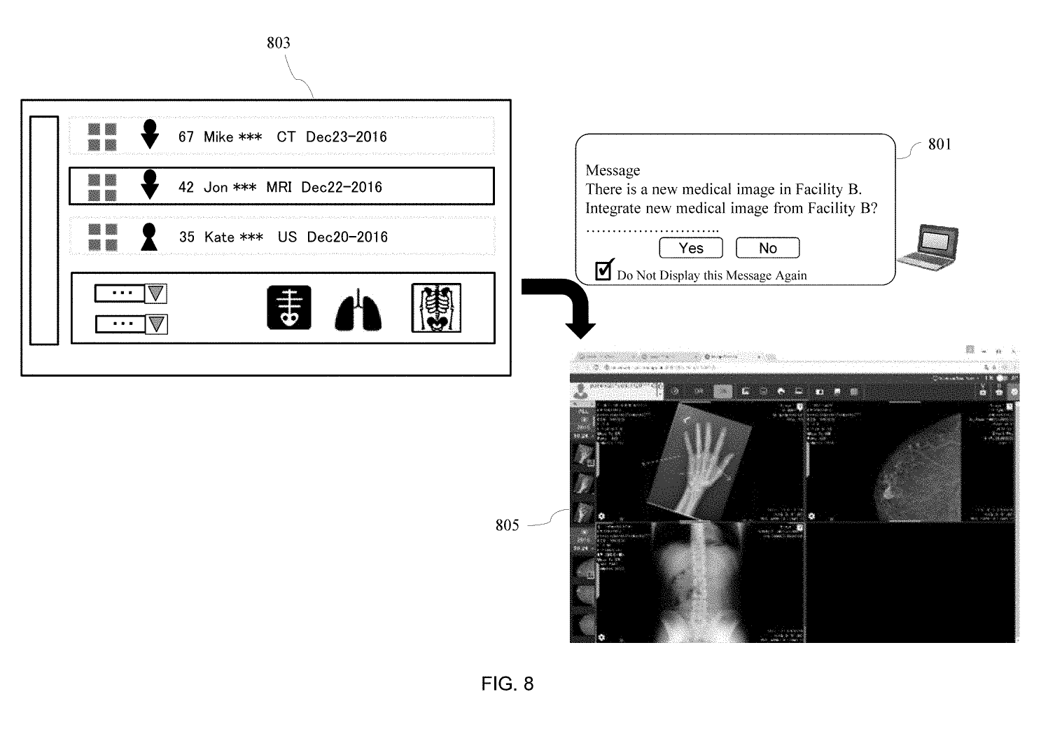

FIG. 8 shows a diagram in accordance with one or more embodiments of the invention that illustrates an event where one of the in-network healthcare facilities updates medical data or adds medical data associated with a patient whose medical data was retrieved by one or more different in-network healthcare facilities.

In one or more embodiments, information of the search parameters associated with patients whose medical data have been previously retrieved are saved so that, at the time a user logs-in to the universal viewer, the universal viewer will automatically perform a search in the background using the saved search parameters. In the event that the universal viewer determines that one of the network healthcare facilities has updated an existing medical data or added a new medical data associated with a previously searched patient, the universal viewer will display a pop-up display (801) to the user to indicate that medical data associated with a previously searched patient has been changed. In one or more embodiments, the automatic search conducted in the background may also be performed by the universal viewer at predetermined intervals based on a user preference when the universal viewer is open.

In one or more embodiments as shown in FIG. 8, the universal viewer will display the pop-up display message (801) to a user atone or more in-network healthcare facilities that have retrieved medical data associated with a patient (e.g., Jon Doe with a date of birth of Dec. 22, 2016). The pop-up display message (801) indicates that Facility B has updated the medical data (i.e., added new medical data or modified medical data) associated with the same patient. The pop-up display message (801) asks the user whether the user would like to integrate (i.e., retrieve) the updated medical data from Facility B. The user is also presented with an option to stop the universal viewer from displaying such a message again in the future for the same patient.

In one or more embodiments, if the user chooses to integrate the updated medical data, the universal viewer will retrieve the updated medical data from Facility B, save the updated medical data in the healthcare facility's medical repository, and indicate through a user-interface (803) that updated medical data is available for the patient. The user may then select the patient from the user-interface (803) to see what new medical data is available. As shown in FIG. 6, the type of medical data available is represented through thumbnail versions of medical images. The user may then decide whether to open the updated medical data to view the updated medical data in the web-browser (805) that is displaying the integrated medical data in a tab with the universal viewer open.

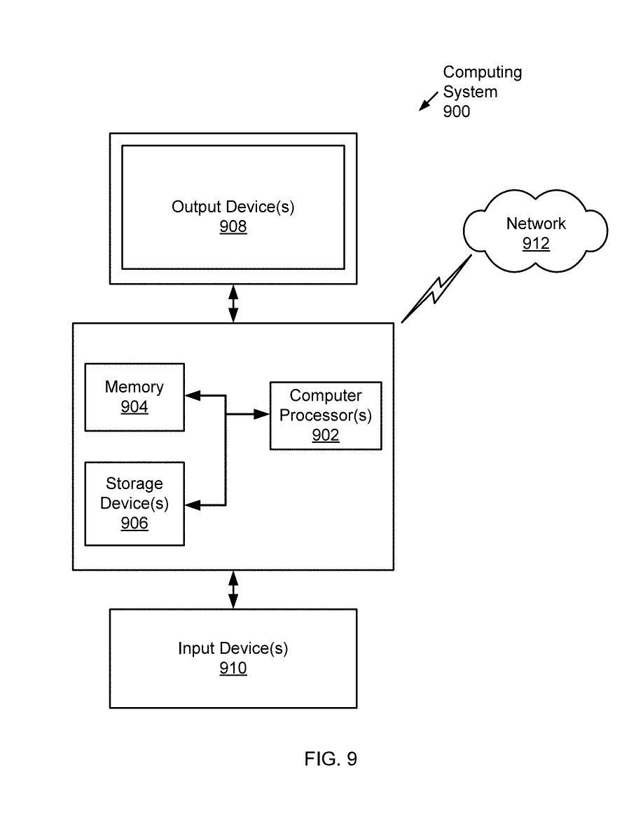

Embodiments of the invention may be implemented on virtually any type of computing system, regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 9, the computing system (900) may include one or more computer processor(s) (902), associated memory (904) (e.g., random access memory (RAM), cache memory, flash memory, etc.), one or more storage device(s) (906) (e.g., a hard disk, an optical drive such as a compact disk (CD) drive or digital versatile disk (DVD) drive, a flash memory stick, etc.), and numerous other elements and functionalities. The computer processor(s) (902) may be an integrated circuit for processing instructions. For example, the computer processor(s) may be one or more cores, or micro-cores of a processor. The computing system (900) may also include one or more input device(s) (910), such as a touchscreen, keyboard, mouse, microphone, touchpad, electronic pen, or any other type of input device. Further, the computing system (900) may include one or more output device(s) (908), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (900) may be connected to a network (912) (e.g., a local area network (LAN), a wide area network (WAN) such as the Internet, mobile network, or any other type of network) via a network interface connection (not shown). The input and output device(s) may be locally or remotely (e.g., via the network (912)) connected to the computer processor(s) (902), memory (904), and storage device(s) (906). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (900) may be located at a remote location and connected to the other elements over a network (912). Further, one or more embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

The computing system of FIG. 9 may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

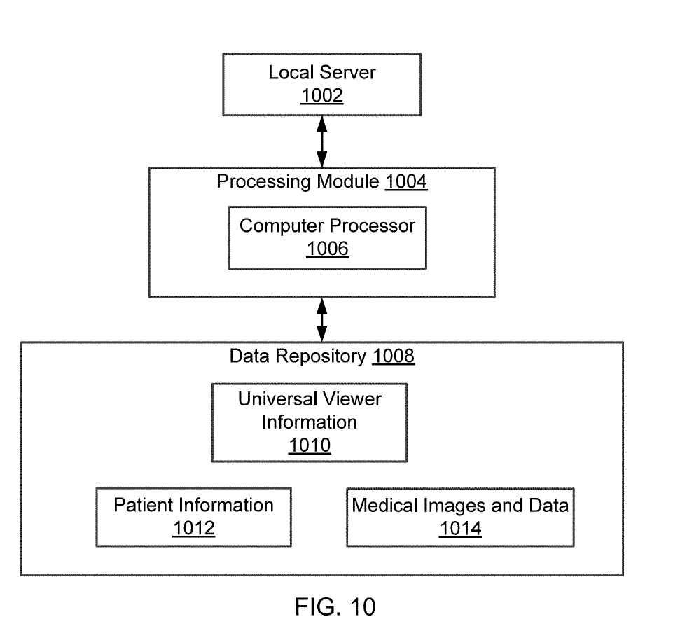

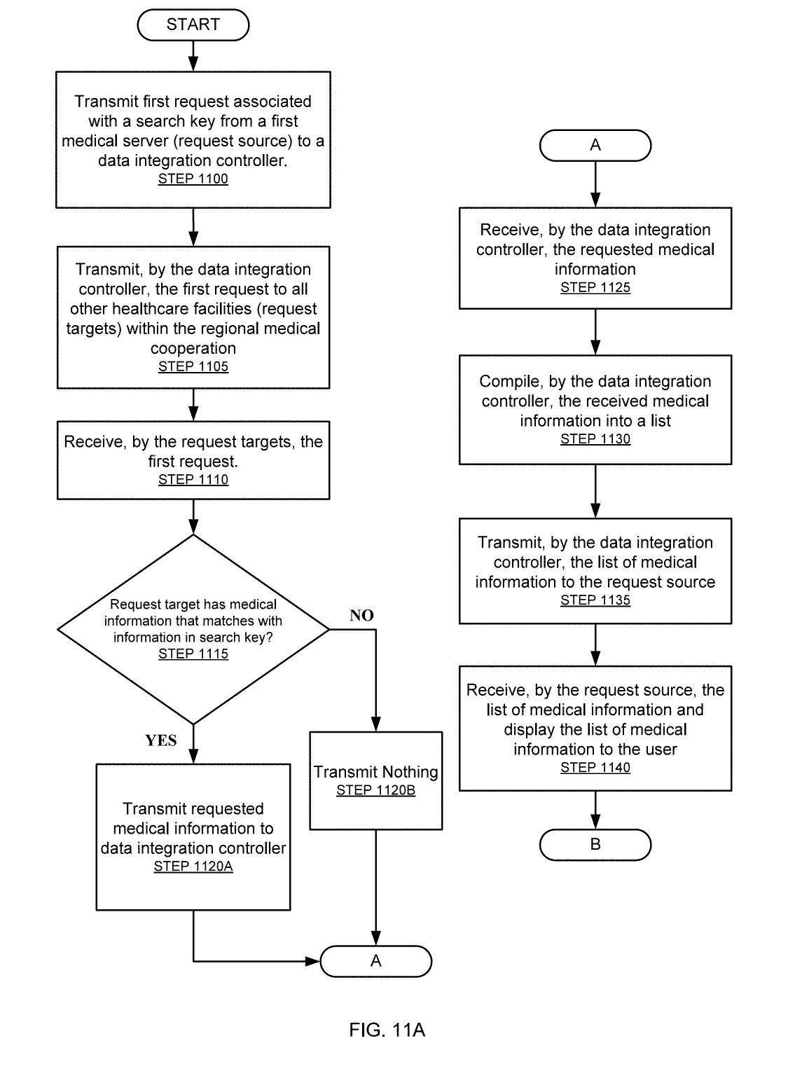

FIG. 10 shows a schematic diagram of a system in accordance with one or more embodiments. The system is configured for searching, extracting, and displaying medical images and data between a plurality of medical repositories on a plurality of medical servers of healthcare facilities within a network. The plurality of medical servers are connected through a data integration controller and comprises a local medical server and two or more remote medical servers.

The system as shown in FIG. 10 may include, for example, (i) a processing module (1004) including a computer processor (1006) configured to execute instructions configured to perform the following steps.

In one aspect, the computer processor (1006) executes instructions to (1) transmit a medical data integration request with a search key associated with a predetermined patient through the data integration controller to the remote medical servers, (2) receive a medical data associated with the medical data integration request from the remote medical servers, (3) display the received medical data as an integrated view, (4) perform post-processing on the received medical data based on an input from a user, (5) store a condition of the performed post-processing, (6) apply the same post-processing condition to medical data received from a subsequent medical data integration request associated with the same search key, and (7) display the medical data received from the subsequent medical data integration request as the integrated view.

The system as shown in FIG. 10 further comprises (ii) a local server (1002) configured to present the medical data to the user. The system may further include a repository (1008) configured to store a universal viewer application information (i.e., data) (1010) related to the vendor provided application, the patient associated information (1012), and the medical data (1014).

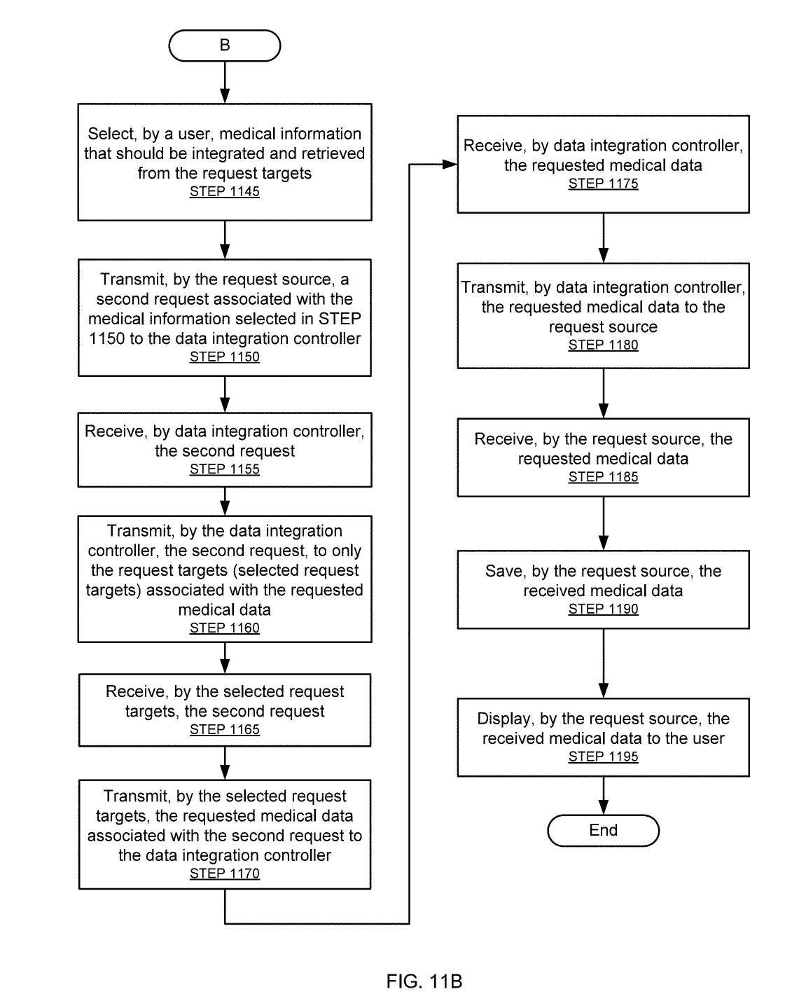

FIGS. 11A and 11B show a flowchart of a method in accordance with one or more embodiments. In one or more embodiments, the method as shown in FIGS. 11A and 11B is a computer-implemented method. Each step shown in FIGS. 11A and 11B are described together below with respect to only a system of one healthcare facility among the multiple in-network healthcare facilities. It would be apparent to one of ordinary skill in the art that each step of the method described below can be performed by any of the systems of the multiple in-network healthcare facilities.

in Step 1100, a patient information search request (“a search request”) is transmitted from a medical server in one of the multiple in-network healthcare facilities (“a request source”) to the data integration controller. The search request includes a search key associated with information of a predetermined patient including the patient's name, the patient's gender, and the patient's date of birth. The user enters in the search information through the universal viewer opened in a web-browser.

In Step 1105, the data integration controller receives the search request from the request source and transmits the search request to all other medical servers of the other in-network healthcare facilities (“request targets”) that are connected to the data integration controller.

In Step 1110, the request targets receive the search request and each request target determines in Step 1115 if their respective medical servers contain medical data with medical information that matches with the patient information included in the search key. In one or embodiments, the medical data must have medical information that matches any number of the patient information included in the search key as long as the results are sufficient to identify the patient of interest accurately with confidence. For example, a match of at least two general search parameters such as gender and either one of a first name or a last name with at least one other more specific parameter such as the patient's full legal name, date of birth, modality type, or facility ID may be required. One of ordinary skill would appreciate that various other combinations may be used that are not specifically shown, e.g., more than two general parameters without a specific parameter, one general parameter with two specific parameters, only two specific parameters, etc.

For the respective request target, if the result in the check in Step 1115 is NO, the request target transmits nothing in Step 1120B.

If the result in the check in Step 1115 is YES, the request target transmits the medical information that matches the patient information included in the search request to the data integration controller in Step 1120. In one or more embodiments, the medical information does not include the actual medical data but rather includes information about the medical data such as Facility Name, Patient Name, Patient Gender, Patient Date of Birth, Latest Visit Date, Examination Data, Number of Images/Reports, etc.

In Step 1125, the data integration controller receives the medical information from all the request targets that produced a YES result in STEP 1115. All of the medical information received by the data integration controller is then compiled by the data integration controller into a list-view format in Step 1130.

In Step 1135, the data integration controller transmits the compiled list of medical information to the request source. The request source displays the compiled list of medical information received from the data integration controller on a display screen of a local computer in Step 1140.

In Step 1145, the user views the received list of medical information and selects all medical information associated with medical data the user wants to retrieve from the request targets. In one or more embodiments, not all of the medical information may be selected. Specifically, not all of the medical information may be relevant or be of interest to the user. For example, the user may not want to retrieve medical data that are outdated, related to a diagnosis that would not be useful for the current diagnosis, or related to a different patient whose information may match part of search key. This not only prevents unnecessary storage costs on the medical repository at the healthcare facility that transmits the request, but also decreases the amount of time required to retrieve the medical data.

In Step 1150, the user's selection is transmitted in a medical data retrieval request (“retrieval request”) from the request source to the data integration controller. The data integration controller receives the retrieval request in Step 1155 and relays the retrieval requests to only the request targets (“selected request targets”) that contain the requested medical data in Step 1160.

In Step 1165, the selected request targets receive the retrieval request in from the data integration controller, and in Step 1170, transmit the medical data that matches the medical data information in the retrieval request to the data integration controller.

In Step 1175, the data integration controller receives the requested medical data transmitted from the selected request targets. In one or more embodiments, upon receipt of all of the requested medical data, the data integration controller creates a data table to store the medical information of the received medical data under a newly created common patient ID (“common PID”). The data table is stored in the integration data repository.

In Step 1180, the data integration controller transmits the medical data received from the selected request targets to the request source.

In Step 1185, the request source receives the medical data transmitted from the data integration controller, integrates and saves the medical data as a single file in the medical repository of the medical server in Step 1190, and displays the received medical data on the display of the local computer in Step 1195. In one or more embodiments, the medical data is displayed by the universal viewer through a tab of a web-browser.

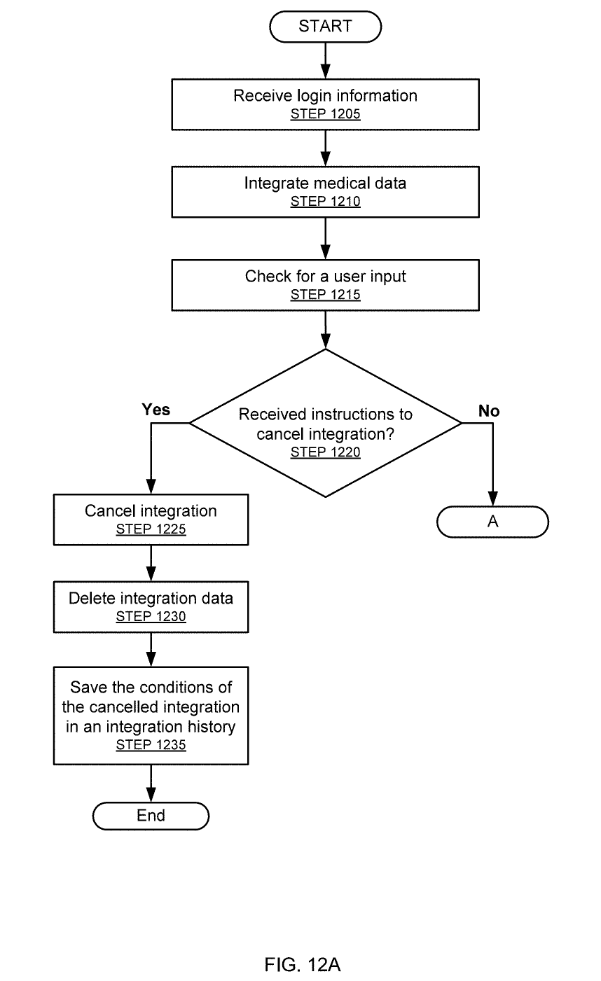

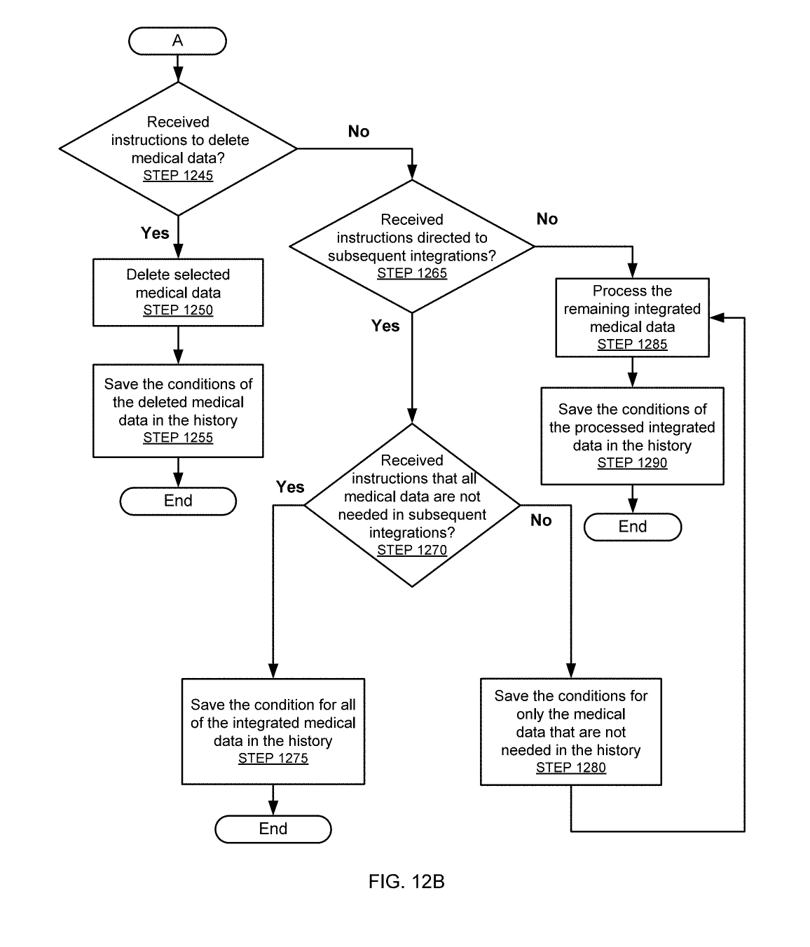

FIG. 12 shows a flowchart of a method in accordance with one or more embodiments. In one or more embodiments, the method as shown in FIGS. 12A and 12B is a computer-implemented method. Each step shown in FIGS. 12A and 12B is described together below with respect to only a system of one healthcare facility among the multiple in-network healthcare facilities. It would be apparent to one of ordinary skill in the art that each step of the method described below can be performed by any of the systems of the multiple in-network healthcare facilities.

In Step 1205, a local computer coupled with a medical server in one of the multiple in-network healthcare facilities (“local medical server”) that has the Universal View application open in a web-browser receives a designated USER ID and a user-set PASSWORD from a user.

In Step 1210, one or more medical data is presented through the universal viewer on the first local computer as an integrated view. In one or more embodiments, the medical data in the integrated view is based on medical data retrieved from a medical data integration request (“integration request”) associated with a predetermined patient.

In one or more embodiments, the medical data in the integrated view may be retrieved based on an automatic integration request sent by the universal viewer to a data integration controller when the user has logged-in to the universal viewer. In one or more embodiments, the automatic integration request sent by the universal viewer is based on information of previous integration requests (“integration history data”) stored in an integration data storage coupled to the data integration controller.

In one or more embodiments, the medical data in the integrated view may be retrieved based on a manual integration request submitted by the user through the universal viewer. At this stage, the user can review all of the medical data presented in the integrated view.

In Step 1215, the local medical server determines whether a user input (i.e., an instruction from the user) has been received by the local computer.

In Step 1220, the local medical server determines whether the received user input is an instruction to cancel the integration.

In one or more embodiments, the user can check the medical data in the integrated view to determine whether any of the medical data presented in the integrated view is associated with a patient that is different from the predetermined patient (“an unrelated patient”) in the integration request. In one or more embodiments, although the possibility that the integrated view includes medical data associated with an unrelated patient is low, it is still possible that such a situation may occur. In the event that this situation does occur, all of the medical data associated with the unrelated patient would have been retrieved and integrated with the medical data of the predetermined patient. Therefore, instead of selecting all unrelated data, the user can instead cancel the present integrated view and modify the search criteria (i.e., the search key) transmitted in a subsequent integration request.

In one or more embodiments, the user can review the results of the check and input instructions to the local computer based on the results. The user may perform the check before the actual integration of all of the medical data when the medical data is displayed in list-view as medical information as described in Step 1130 of the method described with reference to FIGS. 11A and 11B. This enables the user to prevent an integration that would result in a cancelled integration so that the user's time and the local medical server's resources are not wasted in an integration that is sure to be canceled.

If the result of the determination in Step 1220 is YES, the local medical server performs post-processing on the integrated view displayed in the universal viewer to cancel the integrated view in Step 1225.

In Step 1230, the local medical server deletes the data associated with all of the medical data presented in the integrated view stored in the local medical repository coupled with the local medical server.

In Step 1235, the local medical server saves the conditions of the cancelled integrated view in a storage of an information addition controller included in the local medical server. In one or more embodiments, the conditions saved by the local medical server includes information associated with the predetermined patient in the search key transmitted in the medical data integration request and information associated with all of the medical data included in the integrated view that was cancelled. In one or more embodiments, the conditions stored in the additional storage unit are transmitted by the local medical server to the data integration controller to be stored in an integration data repository as an integration history data.

In one or more embodiments, when a subsequent integration request is transmitted by the local medical server to the data integration controller, the data integration controller compares the search key included in the subsequent integration request with the integration history data stored in the integration data repository.

In one or more embodiments, the local medical server will no longer use a search key that is identical to the search key of an integration request that resulted in a cancelled integration view in any subsequent automatic integration requests.

In one or more embodiments, if the search key of the new integration request is identical with the search key of the integration request that resulted in the cancelled integrated view and if the integration request was a manual request by the user, a pop-up window will appear in the universal viewer to notify the user that the user's integration request previously resulted in a cancellation of the integrated view. The user will then be presented with an option to continue the transmission of the present integration request or to modify the information in the search key.

If the result of the determination in Step 1220 is NO, the local medical server determines in Step 1245 whether the received user input is an instruction to delete specific medical data presented in the integrated view.

In one or more embodiments, the user can check the medical data in the integrated view to determine whether any unwanted or unusable medical data are included among the medical data in the integrated view for the current inspection. In one or more embodiments, the user can review the results and input instructions into the local computer based on the result of the check. For example, the unwanted and unusable data for the current inspection may include medical data that are outdated, medical data that contain incomplete medical information within a medical report embedded in a metadata of the medical data, and medical data that include medical images with poor quality that need to be retaken. The information included in the metadata of the medical data is described with reference to FIGS. 5A and 5B.

If the result of the determination in Step 1245 is YES, the local medical server performs post-processing on the integrated view displayed in the universal viewer to delete the specific medical data in Step 1250. In one or more embodiments, the data associated with all of the medical data deleted from the integrated view is permanently deleted from the medical repository of the local medical server.

In Step 1255, the local medical server saves the conditions of the medical data that were deleted from the integrated view in the additional information storage. In one or more embodiments, the conditions saved by the local medical server include information associated with unique information from the metadata of the deleted medical data. In one or more embodiments, the conditions stored in the additional storage unit are transmitted by the local medical server to the data integration controller to be stored in an integration data repository as an integration history data.

In one or more embodiments, when an integrated view is generated for the same predetermined patient, the data integration controller will only integrate the medical data that were not previously deleted by the user. This ensures that subsequently generated integrated views for the same patient will not include any medical data that are outdated, contain incomplete medical information, or contain medical images with poor quality that need to be retaken (i.e., the subsequently generated integrated views for the patient will not include any data that the user has previously decided are unwanted or unusable), which increases the convenience of the user by reducing the amount of data the user would need to look through. This also ensures that only medical data needed by the user is integrated, which reduces the amount of storage space required when compared to integrating all medical data associated with the predetermined patient.

If the result of the determination in Step 1245 is NO, the local medical server determines in Step 1265 whether the received user input is an instruction directed to post-processing for subsequent integrations.

In one or more embodiments, the user checks the medical data in the integrated view to determine whether there are any unwanted medical data for subsequent integrations (i.e., during the patient's next visit, checkup, or diagnosis). In one or more embodiments, the user can perform the check and input instructions to the local computer based on the results of the check. In one or more embodiments, the unwanted data may include medical data that the user concludes will no longer be used or no longer be helpful in performing a diagnosis during the predetermined patient's next visit. For example, if a predetermined patient's integrated view contains five medical data associated with the same broken wrist, the user may choose to only leave one or more for the predetermined patient's medical records and delete the remaining one(s) that the user has concluded to be unneeded.

If the result of the determination in Step 1265 is NO, the local medical server performs post-processing on the remaining medical data in Step 1285 in accordance with instructions received from the user to edit portions of the remaining data using, the image rendering application included with the universal viewer. In one or more embodiments, the metadata of the remaining data to may be edited to include new information related to the diagnosis performed during the current visit and also process the data to cover-up or mask out portions of the metadata that the user concludes is not required for diagnoses to be performed during subsequent visits.

In Step 1290, once the editing of the remaining medical data in the integrated view is complete, the local medical server saves the preferences (i.e., edits) in the additional information storage unit and the integration data repository so that the current edits will be reflected in subsequent integrated views generated for the same predetermined patient. By performing post-processing to edit the remaining data, additional notes may be left within the medical data and unneeded information may be deleted to ensure that the subsequent diagnosis may be performed in a more efficient manner by removing medical information that is not relevant to subsequent diagnoses. Further, this also ensures that additional notes, which are stored in a separate location, about the edits would not need to be kept by the user to prevent the risk of losing the notes before the next diagnosis.

If the result of the determination in Step 1265 is YES, the local medical server determines in Step 1270 whether the received user input indicates that all medical data remaining within the integrated view are unnecessary in subsequent integrations.

In one or more embodiments, the user checks the remaining medical data in the integrated view to determine whether all of the remaining medical data in the integrated view is unwanted for subsequent integrations. In one or more embodiments, the check is performed by the user and the user inputs instructions to the local computer based on the result of the check.

If the result of the determination in Step 1270 is YES, all of the remaining medical data is deleted in Step 1275 from the integrated view and the condition is saved in the additional information storage unit and the integration data repository as integration history data. In one or more embodiments, when a subsequent integrated view is generated for the same predetermined patient, the only medical data available will only be new medical data that the user has not previously determined to be unneeded.

If the result of the determination in Step 1270 is NO, a condition of the remaining medical data in the integrated view that is not needed in subsequent integrations is received by the local medical server in Step 1280. The local medical server saves the condition in the additional information storage unit and the integration data repository as integration history data and the method proceeds to Step 1285 for the local medical server to perform editing on the remaining medical data.

In one or more embodiments, the user selects the medical data among the remaining data that the user has concluded is not needed for subsequent diagnoses.

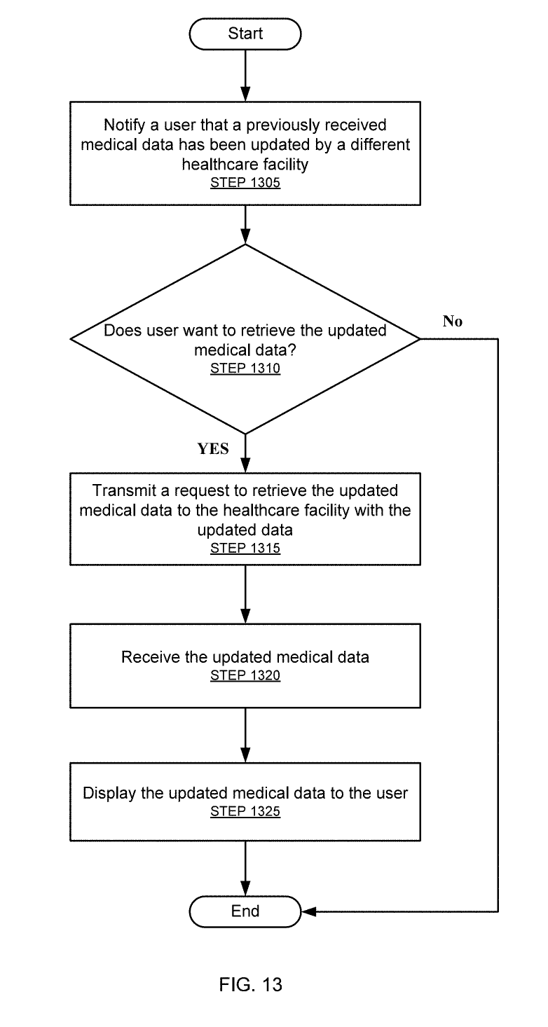

FIG. 13 shows a flowchart of a method in accordance with one or more embodiments. In one or more embodiments, the method as shown in FIG. 13 is a computer-implemented method. Each step shown in FIG. 13 is described together below with respect to only a system of one healthcare facility among the multiple in-network healthcare facilities. It would be apparent to one of ordinary skill in the art that each step of the method described below can be performed by any of the systems of the multiple in-network healthcare facilities.

In Step 1305, a user of a local computer is notified by the universal viewer opened in the local computer through a pop-up display message that a user at a different in-network healthcare facility has added or modified (“updated”) medical data associated with a patient that the present user has previously conducted a search for.

In Step 1310, the local computer receives an input from the user that indicates whether the user wants to retrieve the updated medical data from the other in-network healthcare facility. In one or more embodiments, the local computer simultaneously receives an input from the user that indicates that the user does not want to receive the same message again in the future for the same patient.

If the result of the check in Step 1310 is NO, the process ends. If the result of the check in Step 1310 is YES, the local computer transmits a retrieval request through the medical server to the data integration controller in Step 1315. In one or more embodiments, the data integration controller forwards the request to the in-network healthcare facility that contains the updated data.

In Step 1320, the local computer receives the requested data from the in-network healthcare facility that contains the updated data, and the updated medical data is displayed to the user in Step 1325.

One or more embodiments of the invention may have one or more of the following advantages: the ability to conduct a search for a patient's medical information with only simple information associated with the patient; the ability to retrieve medical data from all healthcare facilities that are part of a network even though each healthcare facility may implement a different medical data storage system and utilize a different type of network; the ability to provide healthcare professionals with a feature to choose which medical data to retrieve; the ability to prevent a huge burden being placed on the connection between the in-network healthcare facilities and the medical servers and medical repositories of each in-network healthcare facilities by not retrieving medical data that is not required by a user; the ability to lessen the burden placed on healthcare professionals by transmitting automatic medical data integration requests based on previously stored integration history data; the ability to provide healthcare professionals with a feature to perform post-processing on medical data integrated from other in-network healthcare facilities so that the healthcare professionals can refine the integrated medical data to increase the efficiency of present and future diagnoses and to reduce the burden placed on the local medical repositories by removing unwanted medical data; the ability to increase the healthcare professional's efficiency and burden in future diagnoses for the same patient by saving the conditions of the performed post-processing and applying the saved post-processing conditions to subsequent medical data integration requests; etc.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method to search, extract, and display medical images and data between a plurality of medical repositories on a plurality of medical servers of healthcare facilities within a network, wherein the plurality of medical servers are connected through a data integration controller and comprises a local medical server and two or more remote medical servers, the method comprising causing the local medical server to:
transmit a medical data integration request through the data integration controller to the remote medical servers, wherein the medical data integration request comprises a search key associated with a predetermined patient;
receive a medical data associated with the medical data integration request from the remote medical servers;
display the received medical data as an integrated view;
perform post-processing on the received medical data based on an input from a user;
store a condition of the performed post-processing;
apply the same post-processing condition to medical data received from a subsequent medical data integration request associated with the same search key; and
display the medical data received from the subsequent medical data integration request as the integrated view.

2. The method according to claim 1, further comprising:
causing the local medical server to:
transmit a search request by the user to the remote medical servers, wherein the search request comprises the search key associated with the predetermined patient;
receive and display medical information associated with the search request from the remote medical servers, wherein the medical information is organized into a user-selectable interface by the data integration controller; and
transmit, to remote medical servers associated with the medical information selected by the user, the medical data integration request to retrieve medical data associated with the medical information selected by the user from the user-selectable interface, wherein the medical data integration request is transmitted only to the remote medical servers associated with the medical information selected by the user.

3. The method according to claim 1, wherein each of the plurality of medical servers is coupled to a local computer.

4. The method according to claim 1, wherein the condition of the performed post-processing is stored in an additional information storage of an information addition controller included in the local medical server, and wherein an information stored in the additional information storage is stored in an integration data repository as an integration history data.

5. The method according to claim 1, wherein the post-processing performed on the received medical data comprises:
cancelling the integrated view,
deleting the received medical data from the integrated view,
hiding a selected medical data in the integrated view among the received medical data,
hiding all received medical data in the integrated view associated with the predetermined patient, and
editing the received medical data in the integrated view.

6. The method according to claim 5, wherein the editing comprises removing a portion of the received medical data.

7. The method according to claim 6, wherein the removed portion is metadata of the received medical data that contain medical information associated with the received medical data.

8. The method according to claim 6, wherein the removing comprises greying out the portion or covering up the portion by masking.

9. The method according to claim 7, wherein the medical information associated with the received medical data that is stored as the metadata comprises a facility ID, the predetermined patient's Patient ID, gender, and date of birth, a date of the predetermined patient's most recent visit, an examination data associated with the medical data, and a number of medical images and reports included in the medical data.

10. The method according to claim 1, wherein the transmission of the medical integration request is automatically initiated by the local medical server.

11. The method according to claim 1, wherein the transmission of the medical integration request is manually initiated by the user.

12. A non-transitory computer-readable medium (CRM) storing instructions that cause a local medical server coupled to a computer to perform an operation to search, extract, and display medical images and data between a plurality of medical repositories on a plurality of medical servers of healthcare facilities within a network, wherein the plurality of medical servers are connected through a data integration controller and comprises the local medical server and two or more remote medical servers, the operation comprising causing the local medical server to:
transmit a medical data integration request through the data integration controller to the remote medical servers, wherein the medical data integration request comprises a search key associated with a predetermined patient;
receive a medical data associated with the medical data integration request from the remote medical servers;
display the received medical data to a user as an integrated view;
perform post-processing on the received medical data based on an input from the user;
store a condition of the performed post-processing;
apply the same post-processing condition to medical data received from a subsequent medical data integration request associated with the same search key; and
display the medical data received from the subsequent medical data integration request as the integrated view.

13. The CRM according to claim 12, further causing the local medical server to
transmit a search request by the user to the two or more remote medical servers, wherein the search request comprises the search key associated with the predetermined patient;
receive and display medical information associated with the search request from the remote medical servers, wherein the medical information is organized into a user-selectable interface by the data integration controller; and
transmit, to the remote medical servers associated with the medical information selected by the user, the medical data integration request to retrieve medical data associated with the medical information selected by the user from the user-selectable interface, wherein the medical data integration request is transmitted only to the remote medical servers associated with the medical information selected by the user.

14. The CRM according to claim 12, wherein each of the plurality of medical servers is coupled to a local computer.

15. The CRM according to claim 12, wherein the conditions of the performed post-processing is stored in an additional information storage of an information addition controller included in the local medical server, and wherein an information stored in the additional information storage is stored in an integration data repository as an integration history data.

16. The CRM according to claim 12, wherein the post-processing performed on the received medical data comprises:
cancelling the integrated view,
deleting the received medical data from the integrated view,
hiding a selected medical data in the integrated view among the received medical data,
hiding all received medical data in the integrated view associated with the predetermined patient, and
editing the received medical data in the integrated view.

17. A system that exchanges medical data between medical severs of healthcare facilities that are part of a network, comprising:
a local medical server with a medical repository, the local medical server comprising an information addition controller with a data processing unit and an additional information storage unit; and
a data integration controller with a communication interface (I/F) circuit that connects the local medical server with two or more remote medical servers with respective medical repositories, wherein
the local medical server:
transmits a medical data integration request through the data integration controller to the remote medical servers, wherein the medical data integration request comprises a search key associated with a predetermined patient;
receives a medical data associated with the medical data integration request from the remote medical servers;
displays the received medical data to a user as an integrated view;
performs post-processing on the received medical data based on an input from the user;
stores a condition of the performed post-processing;
applies the same post-processing condition to medical data received from a subsequent medical data integration request associated with the same search key; and
displays the medical data received from the subsequent medical data integration request as the integrated view.

18. The system according to claim 17, wherein the local medical server
transmit a search request by a user to the remote medical servers, wherein the search request comprises the search key associated with the predetermined patient;
receive and display medical information associated with the search request from the remote medical servers, wherein the medical information is organized into a user-selectable interface by the data integration controller; and
transmit, to the remote medical servers associated with the medical information selected by the user, the medical data integration request to retrieve medical data associated with the medical information selected by the user from the user-selectable interlace, wherein the medical data integration request is transmitted only to the remote medical servers associated with the medical information selected by the user.

19. The system according to claim 17, wherein the local medical server is coupled to a local computer and the conditions of the performed post-processing is stored in an additional information storage of an information addition controller included in the local medical server, and wherein an information stored in the additional information storage is stored in an integration data repository as an integration history data.

20. The system according to claim 17, wherein the post-processing performed on the received medical data comprises:
cancelling the integrated view,
deleting the received medical data from the integrated view,
hiding a selected medical data in the integrated view among the received medical data,
hiding all received medical data in the integrated view associated with the predetermined patient, and
editing the received medical data in the integrated view.
